(19) United States
(12) Patent Application Publication
(10) Pub. No.: US 2016/0280861 A1
(43) Pub. Date: Sep. 29, 2016

(54) Photo-Dimerization Functional Group-Containing Organopolysiloxane, Activation Energy Radiation-Curable Organopolysiloxane Composition, And Cured Product Thereof

(71) Applicant: DOW CORNING TORAY CO., LTD., Tokyo (JP)

(72) Inventor: Takuya Ogawa, Ichihara-shi (JP)

(21) Appl. No.: 14/442,529

(22) PCT Filed: Nov. 13, 2013
(86) PCT No.: PCT/JP2013/081330

§ 371 Date: May 13, 2015

(30) Foreign Application Priority Data
Nov. 14, 2012 (JP) 2012-250141

(51) Int. Cl. C08G 77/20

(52) U.S. Cl. CPC C08G 77/20

(57) ABSTRACT

The present invention relates to a photo-dimerization functional group-containing organopolysiloxane represented by the following formula (1): (R₃SiO_{1/2})ₘ (R₂SiO_{2/2})ₙ (RSiO_{3/2})ₚ (SiO_{4/2})_{q} (1) wherein, R are each independently selected from the group consisting of monovalent hydrocarbon groups, alkoxy groups having 1 to 6 carbon atoms, photo-dimerization functional groups, and hydroxyl groups, provided that an average of at least three R in a molecule are the photo-dimerization functional groups; and m, n, p, and q are each numbers greater than or equal to 0, and satisfy the following condition: 3.0≦m+n≦20,000. The photo-dimerization functional group-containing organopolysiloxane cures rapidly due to irradiation by activation energy radiation such as ultraviolet radiation or the like.

### TECHNICAL FIELD

The present invention relates to a photo-dimerization functional group-containing organopolysiloxane, an activation energy radiation-curable organopolysiloxane composition including such an organopolysiloxane, and a cured product of such a composition.

Priority is claimed on Japanese Patent Application No. 2012-250141, filed on Nov. 14, 2012, the content of which is incorporated herein by reference.

### BACKGROUND ART

Organopolysiloxane type materials, i.e. silicon-containing polymers, have excellent photo-transparency, electrical insulation ability, photo-stability, heat resistance, cold resistance, and the like, and thus such organopolysiloxane type materials are used in most industrial fields such as electrical and electronics applications, construction, automobiles, machines, chemicals, biochemistry, and the like. One processing method for such organopolysiloxane based materials is curing by light or electron beam. Curing by light or electron beam is advantageous from the standpoint of low energy consumption and high productivity, and curing by light or electron beam is typically used for coating applications.

Such polysiloxane type material is proposed in Japanese Unexamined Patent Application Publication No. H05-309664, for example, as a peelable silicone composition mainly composed of an organopolysiloxane having a (meth)acryl group at both terminals. Moreover, in Japanese Unexamined Patent Application Publication No. 2005-163009 there is a proposal for an organopolysiloxane resin that is curable by high energy radiation and has (meth)acryloxy groups, as a raw material useful for a light transmission member. However, although these (meth)acrylic type organopolysiloxanes are capable of providing a cured product by curing by polymerization reaction of the (meth)acryl group or (meth)acryloxy groups, there has been concern about the effect of the utilized polymerization initiator and decomposition product thereof on long-term stability of the cured article. Moreover, the cured product of the organopolysiloxane having a poly(meth)acrylic backbone or poly(meth)acroyl backbone has had problems in that heat resistance is poor due to having such a backbone.

In contrast, Japanese Unexamined Patent Application Publication Nos. 2002-241504 and 2010-241948, for example, propose curable silicone compositions that include an organopolysiloxane having a cation polymerizable group such as an epoxy group or the like. Curing through cationic polymerization through ring-opening of the epoxy groups of such compositions is advantageous in that there is no inhibition of curing due to oxygen. However, such organopolysiloxanes having these epoxy groups readily undergo ring-opening polymerization if an acid-forming agent and, as may be the case, a catalyst are used. Thus the residual catalyst or the like of the cured product has resulted in concern about long-term stability of the cured product. Moreover, there has been a problem of such organopolysiloxanes having water absorbency due to a hydroxyl group generated by the ring-opening reaction.

In Japanese Unexamined Patent Application Publication No. 2003-268107 an octasiloxane polymer is proposed that includes a pentacyclooctasiloxane backbone as a curable organopolysiloxane using a dimerization reaction due to irradiation by light. However, adjustment of the density of crosslinking is difficult for this pentacyclooctasiloxane, and there has been a problem in that the cured product has no flexibility.

Furthermore, Japanese Unexamined Patent Application Publication no. 2012-144610 contains a proposal for a photoreactive polymer that has a photo-dimerization functional group so that the photoreactive polymer may be used as a material for forming a fine pattern. This photoreactive polymer is assumed to be used for an optical recording material or the like, and there has been a problem in that heat resistance is poor.

An object of the present invention is to solve the aforementioned problem by providing a photo-dimerization functional group-containing organopolysiloxane for rapid curing through irradiation by activation energy radiation such as ultraviolet radiation or the like. Another object of the present invention is to provide a cured product of an organopolysiloxane composition that has flexibility and excellent heat resistance.

### DISCLOSURE OF INVENTION

The present inventors arrived at the present invention as a result of conducting dedicated research in order to achieve the objective described above. That is to say, the objects of the present invention are attained by a photo-dimerization functional group-containing organopolysiloxane represented by the following formula (1):

(R₃SiO_{1/2})ₘ(R₂SiO_{2/2})ₙ(RSiO_{3/2})ₚ (SiO_{4/2})_{q} (1)

wherein, R are each independently selected from the group consisting of monovalent hydrocarbon groups, alkoxy groups having 1 to 6 carbon atoms, photo-dimerization functional groups, and hydroxyl groups, provided that an average of at least three R in a molecule are photo-dimerization functional groups; and m, n, p, and q are each numbers greater than or equal to 0, and satisfy the following condition: 3.0≦m+n≦20,000.

The photo-dimerization functional group preferably is a non-hydrolyzable organic group comprising 0 to 2 oxygen atoms and 6 to 20 carbon atoms.

The photo-dimerization functional group preferably is an organic group comprising at least one selected from the group consisting of an anthracenyl group, a chalcone group, a coumarin group, a cinnamic acid group, a stilbenyl group, a thymine group, a maleimide group, an azobenzyl group, and a styrene group.

The present invention relates to an activation energy radiation-curable organopolysiloxane composition comprising the aforementioned photo-dimerization functional group-containing organopolysiloxane.

The activation energy radiation-curable organopolysiloxane composition preferably comprises:

(A) 100 parts by mass of the photo-dimerization functional group-containing organopolysiloxane;
(B) 0 to 10 parts by mass of a photosensitizer; and
(C) 0 to 5,000 parts by mass of an organic solvent.

The activation energy radiation is preferably ultraviolet light.

The present invention relates to a cured product of the aforementioned activation energy radiation-curable organopolysiloxane composition.

### Effects of Invention

According to the present invention, it is possible to provide a photo-dimerization functional group-containing organopolysiloxane that cures rapidly through irradiation by activation energy radiation such as ultraviolet radiation or the like. The present invention is also able to provide an activation energy radiation-curable organopolysiloxane composition including such a photo-dimerization functional group-containing organopolysiloxane.

Moreover, the activation energy radiation-curable organopolysiloxane composition of the present invention is flexible and has quite excellent heat resistance in comparison to the conventional curable organopolysiloxane composition.

### DETAILED DESCRIPTION OF THE INVENTION

The photo-dimerization functional group-containing organopolysiloxane of the present invention is represented by the following formula (1):

(R₃SiO_{1/2})ₘ(R₂SiO_{2/2})ₙ(RSiO_{3/2})ₚ(SiO_{4/2})_{q} (1)

wherein, R are each independently selected from the group consisting of monovalent hydrocarbon groups, alkoxy groups having 1 to 6 carbon atoms, photo-dimerization functional groups, and hydroxyl groups, provided that an average of at least three R in a molecule are the photo-dimerization functional groups; and m, n, p, and q are each numbers greater than or equal to 0, and satisfy the following condition: 3.0≦m+n≦20,000.

The photo-dimerization functional group-containing organopolysiloxane of the present invention may have a molecular structure that is linear, partially-branched linear, branched, or resinous. Further, although the synthesis has been reported of a silicon-containing conjugated polymer having a stilbene structure in the main chain (Journal of the Japan Society of Colour Material, volume 83, pp. 374 to 377), the photo-dimerization functional group is present in the side chain of the polysiloxane main chain of the photo-dimerization functional group-containing organopolysiloxane of the present invention.

The monovalent hydrocarbon group for R in the formula (1) is substituted or non-substituted and is: a monovalent saturated hydrocarbon group having 1 to 30 carbon atoms, preferably having 1 to 10 carbon atoms, further preferably having 1 to 4 carbon atoms; or a monovalent aromatic hydrocarbon group having 6 to 30 carbon atoms, and further preferably having 6 to 12 carbon atoms; as exemplified by alkyl groups such as a methyl group, ethyl group, propyl group, butyl group, pentyl group, hexyl group, heptyl group, or the like; alkenyl groups such as a vinyl group, allyl group, butenyl group, pentenyl group, hexenyl group, or the like; aryl groups such as a phenyl group, tolyl group, xylyl group, naphthyl group, or the like; aralkyl groups such as a benzyl group, phenethyl group, or the like; as well as halogen-substituted alkyl groups such as a chloromethyl group, 3-chloropropyl group, 3,3,3-trifluoropropyl group, nonafluorobutyl ethyl group, or the like.

The alkoxy group having 1 to 6 carbon atoms for R in the formula (1) is exemplified by a methoxy group, ethoxy group, propoxy group, butoxy group, methoxyethoxy group, or the like.

The photo-dimerization functional group for R in the formula (1) is preferably a non-hydrolyzable organic group that has 0 to 2 oxygen atoms and 6 to 20 carbon atoms.

The photo-dimerization functional group is particularly preferably at least one type of organic group selected from the group consisting of an anthracenyl group, chalcone group, coumarin group, cinnamic acid group, stilbenyl group, thymine group, maleimide group, azobenzyl group, and styrene group. Among such photo-dimerization functional groups, organic groups including a cinnamic acid group or stilbenyl group are preferred.

At least an average of three R in the formula (1) are the photo-dimerization functional groups. The photo-dimerization functional group may be present at the molecular chain side chains of the photo-dimerization functional group-containing organopolysiloxane of the present invention, may be present at one terminal of the molecular chain, and may be present at both terminals of the molecular chain. From the standpoint of curability of the photo-dimerization functional group-containing organopolysiloxane of the present invention, the content of the photo-dimerization functional group is preferably in the range of 0.01 to 70 mol % of R in the formula (1), further preferably is in the range of 0.05 to 50 mol %, and most preferably is in the range of 0.10 to 40 mol %.

The respective values of m, n, p, and q in the formula (1) must be numbers greater than or equal to 0, and must satisfy the following condition: 3.0≦m+n≦20,000. Preferably m>0 and/or n>0. Moreover, m and n preferably satisfy the following condition: 3.0≦m+n≦10,000, and further preferably satisfy the following condition: 3.0≦m+n≦3,000. Furthermore, m, n, p, and q preferably satisfy the following condition: 3.0≦m+n+p+q≦10,000, and further preferably satisfy the following condition: 3.0≦m+n+p+q≦3,000.

As measured by GPC (Gel Permeation Chromatography) using tetrahydrofuran (THF) as a solvent, the photo-dimerization functional group-containing organopolysiloxane of the present invention preferably has a weight average molecular weight in the range of 500 to 1,000,000, further preferably has a weight average molecular weight in the range of 1,000 to 100,000, and most preferably has a weight average molecular weight in the range of 1,000 to 10,000.

The photo-dimerization functional group-containing organopolysiloxane of the present invention at room temperature may be solid, raw rubber-like, or liquid. If the photo-dimerization functional group-containing organopolysiloxane of the present invention is a liquid at room temperature, the viscosity at 25° C. is preferably 1 mPa·s to 10,000 mPa·s.

The photo-dimerization functional group-containing organopolysiloxane of the present invention may be produced by known methods. For example, production is possible by hydrolysis and condensation of a hydrolyzable silane compound represented by the following general formula (2):

Xᵣ(R¹)ₛSi(R²)₄₋ᵣ₋ₛ (²)

wherein, X indicates a respective independent photo-dimerization functional group; R¹ indicates a respective independent non-hydrolyzable organic group having 1 to 12 carbon atoms; R² indicates a respective independent hydrolyzable group or hydroxyl group; r is an integer that is 1 or 2; and s is an integer that is 0, 1, or 2.

This method is suitable due to the ability to lower impurities in the obtained organopolysiloxane by the easy removal of the catalyst and reaction byproducts.

The photo-dimerization functional group for X in the formula (2) is exemplified by the photo-dimerization functional groups defined as R in the formula (1).

The non-hydrolyzable organic group having 1 to 12 carbon atoms for R¹ in the formula (2) indicates a group capable of stably existing without the formation of a silanol group due to reaction with water. Such a non-hydrolyzable organic group is exemplified by alkyl groups such as a methyl group, ethyl group, propyl group, butyl group, pentyl group, hexyl group, heptyl group, or the like; alkenyl groups such as a vinyl group, allyl group, butenyl group, pentenyl group, hexenyl group, or the like; aryl groups such as a phenyl group, tolyl group, xylyl group, naphthyl group, or the like; aralkyl groups such as a benzyl group, phenethyl group, or the like; as well as substituted alkyl groups such as a chloromethyl group, 3-chloropropyl group, 3,3,3-trifluoropropyl group, nonafluorobutyl ethyl group, or the like.

The hydrolyzable group for R² in the formula (2) indicates a group capable of forming a silanol group due to reaction with water, and capable of forming a siloxane bond by condensation reaction between the formed silanol groups or between a formed silanol group and a non-reacted hydrolyzable group. The hydrolyzable group for R2 in the formula (2) is exemplified by alkoxy groups having 1 to 6 carbon atoms such as a methoxy group, ethoxy group, or the like; halogeno groups such as a chloro group or the like; and acyloxy groups such as an acetoxy group or the like.

The hydrolysis may be performed in the presence of a strong acid catalyst such as hydrochloric acid, sulfuric acid, trifluoroacetic acid, p-toluene sulfonic acid, trifluoromethane sulfonic acid, or the like, for example.

The reaction temperature of this hydrolysis is preferably −10 to 100° C., and further preferably is 30 to 80° C.

After the condensation reaction, the acid catalyst used in the condensation reaction may be neutralized by addition of a basic compound to this reaction mixture. The basic compound used for neutralization is exemplified by potassium hydroxide; basic inorganic salts such as sodium hydrogen carbonate, sodium carbonate, potassium carbonate, or the like; and organic bases such as triethylamine, tributylamine, ammonia, pyridine, or the like. The utilized amount of such basic compounds is an amount at least equivalent of that for neutralization. The utilized amount of the basic compound, relative to the acid catalyst used in the condensation reaction, is preferably greater than or equal to 1 equivalent and less than or equal to 10 equivalents. Moreover, the acid generated by the condensation reaction may be readily removed by conversion to the corresponding salt, transfer from the organic phase to the aqueous phase, and liquid separation processing.

Moreover, the organosiloxane including the photo-dimerization functional group of the present invention may be produced by hydrosilylation reaction of a compound having the photo-dimerization functional group and an alkenyl group with a silicon atom-bonded hydrogen atom-containing organopolysiloxane.

The hydrosilylation reaction is preferably performed in the presence of a catalyst. Examples of the catalyst include platinum, ruthenium, rhodium, palladium, osmium, iridium, and similar compounds, and platinum compounds are particularly effective due to their high catalytic activity. Examples of the platinum compound include chloroplatinic acid; platinum metal; platinum metal supported on a carrier such as platinum supported on alumina, platinum supported on silica, platinum supported on carbon black, or the like; and a platinum complex such as platinum-vinylsiloxane complex, platinum-phosphine complex, platinum-phosphite complex, platinum alcoholate catalyst, or the like.

A usage amount of the catalyst is about 0.5 to 1,000 ppm in terms of platinum metal, when using a platinum catalyst.

With respect to the activation energy radiation-curable organopolysiloxane composition of the present invention, the composition is characterized as comprising the photo-dimerization functional group-containing organopolysiloxane of the present invention as an activation energy radiation-curable organopolysiloxane.

The activation energy radiation-curable organopolysiloxane composition of the present invention preferably comprises:

(A) 100 parts by mass of the photo-dimerization functional group-containing organopolysiloxane of the present invention,
(B) 0 to 10 parts by mass of a photo sensitizer; and
(C) 0 to 5,000 parts by mass of an organic solvent.

As may be required, a photosensitizer may be blended in the activation energy radiation-curable organopolysiloxane composition of the present invention. A generally known aromatic type compound including a carbonyl may be used as the photosensitizer, without particular limitation, as long as the compound has a photosensitization effect, is miscible with the photo-dimerization functional group-containing organopolysiloxane for component (A), and is soluble in component (C). The photosensitizer is exemplified by isopropyl-9H-thioxanthen-9-one, xanthone, anthracene, anthrone, anthraquinone, benzophenone, 4,4′-bis(dimethylamino)benzophenone, diethoxyacetophenone, 2,2-dimethoxy-1,2-diphenylethan-1-one, 1-hydroxy-cyclohexyl-phenylketone, 2-hydroxy-2-methyl-1-phenylpropan-1-one, 2-methyl-1-[4-(methylthio)phenyl]-2-morpholinopropan-1-one, 1-[4-(2-hydroxyethoxy)phenyl]-2-hydroxy-2-methyl-1-propan-1-one, 2-benzyl-2-dimethylamino-1-(4-morpholinophenyl)butan-1-one, and bis(2,4,6-trimethylbenzoyl)phenylphosphine oxide.

Although no particular limitation is placed on the content of the photosensitizer included in the activation energy radiation-curable organopolysiloxane composition of the present invention, this content relative to 100 parts by mass of the photo-dimerization functional group-containing organopolysiloxane of the present invention is preferably 0 to 10 parts by mass, and further preferably is 0.1 to 5 parts by mass. When the upper limit of the blended amount of photosensitizer is exceeded, there is a tendency for the transparency and strength of the cured product of the activation energy radiation-curable organopolysiloxane composition to decline.

A solvent may be blended in the activation energy radiation-curable organopolysiloxane composition of the present invention, as may be required when component (A) is a solid or viscous liquid. No particular limitation is placed on the organic solvent included in the activation energy radiation-curable organopolysiloxane composition of the present invention as long as the organic solvent is capable of dissolving components (A) and (B) and does not impede photopolymerization performance. The boiling point of this organic solvent is preferably greater than or equal to 80° C. and less than 200° C. The organic solvent is exemplified by i-propyl alcohol, t-butyl alcohol, cyclohexanol, cyclohexanone, methyl ethyl ketone, methyl isobutyl ketone, toluene, xylene, mesitylene, 1,4-dioxane, dibutyl ether, anisole, 4-methylanisole, ethoxybenzene, chlorobenzene, ethylene glycol, ethylene glycol dimethyl ether, ethylene glycol diethyl ether, 2-methoxyethanol, diethylene glycol dimethyl ether, diethylene glycol monomethyl ether, 1-methoxy-2-propyl acetate, 1-ethoxy-2-propyl acetate, octamethylcyclotetrasiloxane, and hexamethyldisiloxane. Such an organic solvent can be used singly or as a mixture of two or more solvents.

Although no particular limitation is placed on the content of the organic solvent included in the activation energy radiation-curable organopolysiloxane composition of the present invention, this content relative to 100 parts by mass of the photo-dimerization functional group-containing organopolysiloxane of the present invention is preferably 0 to 5,000 parts by mass, and further preferably is 0.1 to 1,000 parts by mass. It becomes difficult to obtain a good quality thin film during manufacture of a light-transmitting member if the blended amount of the organic solvent exceeds 5,000 parts by mass.

Various types of previously known methods may be adopted as the method of production of the activation energy radiation-curable organopolysiloxane composition of the present invention. For example, the activation energy radiation-curable organopolysiloxane composition of the present invention may be obtained by blending of components (A) to (C) and other additives. After the aforementioned operation, as may be required, processing may be performed as one or multiple operations such as filtration, pressure reduction, pressurization, heating, cooling, inert gas replacement, or the like.

The activation energy radiation-curable organopolysiloxane composition of the present invention is preferably a liquid at room temperature and preferably has a viscosity at 25° C. of 1 mPa·s to 10,000 mPa·s. The processability of the activation energy radiation-curable organopolysiloxane composition of the present invention during production of the thin film-like cured product becomes poor when the viscosity is outside of this range.

The activation energy radiation-curable organopolysiloxane composition of the present invention is suitable for use in the production of a light-transmitting member, and particularly an optical waveguide.

The activation energy radiation used for curing the activation energy radiation-curable organopolysiloxane composition of the present invention is exemplified by ultraviolet radiation, electron beam, radioactive radiation, or the like. However, from the standpoint of practical application, the activation energy radiation used for curing the activation energy radiation-curable organopolysiloxane composition of the present invention is preferably ultraviolet radiation. The ultraviolet radiation generation source is preferably a high pressure mercury lamp, intermediate pressure mercury lamp, Xe—Hg lamp, deep UV lamp, or the like. The irradiance level of irradiation is preferably 100 to 8,000 mJ/cm².

The cured product of the activation energy radiation-curable organopolysiloxane composition of the present invention is characterized as being produced by curing of the activation energy radiation-curable organopolysiloxane composition of the present invention.

The cured product of the activation energy radiation-curable organopolysiloxane composition of the present invention may be produced by application of the activation energy radiation-curable organopolysiloxane composition on a substrate, and then irradiating the coated composition using activation energy radiation, to produce a light transmission member that has high optical transmissivity in the designated wavelength region. However, as may be required, a film-like light-transmitting member may be obtained by peeling the cured product from the substrate. Such a light-transmitting member that is not attached to the substrate is useful due to the increased degree of freedom in the construction of the light-transmitting system due to the ability for the light-transmitting member to be arranged at a desired location in the light transmission path. Although no particular limitation is placed on the thickness of this film-like light transmission member, the thickness is generally in the range of 5 to 200 μm. Moreover, no particular limitation is placed on the method of peeling of the light transmission member from the substrate, and it is possible to use mechanical peeling using a precision jig or the like, or chemical peeling using a reagent such as an acid or the like.

### EXAMPLES

The present invention is described in detail below based on examples, but the present invention is not limited to the examples. In the examples, the content of the components referred to as “parts” means “parts by mass”. Moreover, Me indicates a methyl group, Ph indicates a phenyl group, Vi indicates a vinyl group, Ac indicates a 3-acryloxypropyl group, and Stil indicates a 4-(trans-stilbenyl) group. The structure of 4-(trans-stilbenyl) group is represented below.

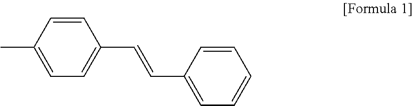

### [Structural Analysis]

The structure of the synthesized polysiloxane having, on silicon atoms, organic groups that dimerize due to activation energy radiation was determined using ²⁹Si nuclear magnetic resonance analysis (nuclear magnetic resonance spectrometer model AC 300P, manufactured by Bruker Corporation) in heavy acetone.

### [Weight Average Molecular Weight]

Tetrahydrofuran was used as the solvent to produce a 0.3% by mass concentration test solution. Gel permeation chromatography (GPC) using an RI detector was used, and the weight average molecular weight and degree of dispersion were calculated by comparison to polystyrene standards.

[Activation energy radiation source]

A deep UV irradiation apparatus manufactured by Yamashita Denso Corporation was used. The energy radiation dose at 365 nm wavelength was 46 mW/cm², and the dose at 254 nm was 4 mW/cm².

### [Heat Resistance]

The heat resistance of the cured product was evaluated by heat treating the cured thin film on the substrate at 260° C. for 5 minutes, and then visually inspecting the heat treated thin film.

### Practical Example 1

Preparation of 4-(trans-stilbenyl) Group-Containing Organopolysiloxane (Al)

A mixture of 99.15 g of phenyltrimethoxysilane, 47.65 g of methyltrimethoxysilane, and 36.8 g of 1,3-(4-(trans-stilbenyl))-1,1,3,3-tetramethyldisiloxane was co-hydrolyzed at room temperature in a mixture of 380 mL of toluene, 50 mL of water, and 250 mg of trifluoromethane sulfonic acid. The condensation reaction proceeded while the generated alcohol was removed by heating to 90° C. Then 2.0 g of 20% by weight potassium hydroxide aqueous solution was added to the obtained 4-(trans-stilbenyl) group-containing organopolysiloxane solution. Water, methanol, and toluene were removed by co-distillation dewatering while the mixture was stirred and heated. Toluene was added, as required, during the operation so as to maintain the solids content at about 70% by weight. After cooling of the mixture, the reaction system was neutralized using a solid acidic absorption agent. The absorption agent was removed by filtration. The filtrate solution was washed twice with water. By removal of toluene under vacuum, 119 g of the 4-(trans-stilbenyl) group-containing organopolysiloxane was obtained as a light yellow solid having the average unit formula of

[Me₂(Stil)SiO_{1/2}]_{5.4} [PhSiO_{3/2}]_{18.0} [MeSiO_{3/2}]_{12.6}. ²⁹Si NMR(δ; ppm):2,-68,-79. Weight average molecular weight: 4,500 (degree of dispersion: 1.4).

### Reference Example 1

Preparation of Vinyl Group-Containing Organopolysiloxane (B1)

97.2 g of a vinyl group-containing organopolysiloxane was obtained having the average unit formula of [me₂ViSiO_{1/2}]_{5.4} [PhSiO_{3/2}]_{18.0} [MeSiO_{3/2}]_{12.6} by the same operation as that of Practical Example 1 except for use of 14.0 g of 1,3-divinyl-1,1,3,3-tetramethyldisiloxane rather than 36.8 g of 1,3-(4-(trans-stilbenyl))-1,1,3,3-tetramethydisiloxane. ²⁹Si NMR(δ; ppm): -1,-68,-79. Weight average molecular weight: 5,100 (degree of dispersion: 1.5).

### Reference Example 2

Preparation of Acryloxy Group-Containing Organopolysiloxane (B2)

According to the Reference Example 1 of Japanese Unexamined Patent Application Publication No. 2005-163009, an acryloxy group-containing organopolysiloxane was prepared that had a weight average molecular weight of 6,000 and an average unit formula of [Me₂SiO_{2/2}]_{2.0} [PhSiO_{3/2}]_{23.5} [ACSiO_{3/2}]_{17. 0}.

### Practical Example 2

A 50% by weight toluene solution of Al was prepared. This polysiloxane solution was spin coated for 5 seconds at 500 rpm on a silicon substrate, and then the toluene was removed by leaving the substrate for 5 minutes at 80° C. temperature. The thin film on the silicon substrate was irradiated by ultraviolet radiation for 85 seconds (irradiation dose of 3.9 J/cm² at 365 nm) to obtain a cured product of 4-(trans-stilbenyl) group-containing organopolysiloxane. The weight average molecular weight of the cured product was 8,800 (degree of dispersion: 2.0). Although the cured thin film was heat treated for 5 minutes at 260° C., there was no visible change in the cured thin film.

### Comparative Example 1

A 50% by weight toluene solution of B1 was prepared. This solution was spin coated by the same method as that of Practical Example 2 to form a thin film, and the thin film was irradiated by ultraviolet radiation in the same manner as in Practical Example 2.

The thin film did not cure, and the weight average molecular weight was 5,100 (degree of dispersion: 1.5).

### Comparative Example 2

A 50% by weight toluene solution of B2 was prepared. This solution was spin coated by the same method as that of Practical Example 2 to form a thin film, and the thin film was irradiated by ultraviolet radiation in the same manner as in Practical Example 2. Although the thin film cured, when the cured thin film was heat treated for 5 minutes at 260° C., cracks were observed on the film, indicating that heat resistance was inferior to that of the cured thin film of Practical Example 2.

### INDUSTRIAL APPLICABILITY

The photo-dimerization functional group-containing organopolysiloxane of the present invention is used as the main component of the activation energy radiation-curable organopolysiloxane composition. The activation energy radiation-curable organopolysiloxane composition of the present invention is useful for production of an optical member. Moreover, the cured product of the activation energy radiation-curable organopolysiloxane composition of the present invention is useful as an optical member such as a light transmission member or the like.

1. A photo-dimerization functional group-containing organopolysiloxane represented by the following formula (1):
(R₃SiO_{1/2})ₘ(R₂SiO_{2/2})ₙ(RSiO_{3/2})ₚ(SiO_{4/2})_{q} (1)
wherein each R is independently selected from the group consisting of monovalent hydrocarbon groups, alkoxy groups having 1 to 6 carbon atoms, photo-dimerization functional groups, and hydroxyl groups, provided that an average of at least three R in a molecule are photo-dimerization functional groups; and m, n, p, and q are each numbers greater than or equal to 0, and satisfy the following condition: 3.0≦m+n≦20,000.

2. The photo-dimerization functional group-containing organopolysiloxane according to claim 1, wherein the photo-dimerization functional group is a non-hydrolyzable organic group comprising 0 to 2 oxygen atoms and 6 to 20 carbon atoms.

3. The photo-dimerization functional group-containing organopolysiloxane according to claim 1, wherein the photo-dimerization functional group is an organic group comprising at least one selected from the group consisting of an anthracenyl group, a chalcone group, a coumarin group, a cinnamic acid group, a stilbenyl group, a thymine group, a maleimide group, an azobenzyl group, and a styrene group.

4. An activation energy radiation-curable organopolysiloxane composition comprising the photo-dimerization functional group-containing organopolysiloxane claimed in claim 1.

5. The activation energy radiation-curable organopolysiloxane composition according to claim 4, comprising:
(A) 100 parts by mass of the photo-dimerization functional group-containing organopolysiloxane;
(B) 0 to 10 parts by mass of a photosensitizer; and
(C) 0 to 5,000 parts by mass of an organic solvent.

6. The activation energy radiation-curable organopolysiloxane composition according to claim 4, wherein the activation energy radiation is ultraviolet radiation.

7. A cured product of the activation energy radiation-curable organopolysiloxane composition claimed in claim 4.

8. The photo-dimerization functional group-containing organopolysiloxane according to claim 2, wherein the photo-dimerization functional group is an organic group comprising at least one selected from the group consisting of an anthracenyl group, a chalcone group, a coumarin group, a cinnamic acid group, a stilbenyl group, a thymine group, a maleimide group, an azobenzyl group, and a styrene group.

9. The photo-dimerization functional group-containing organopolysiloxane according to claim 1, wherein the photo-dimerization functional group is an organic group comprising a cinnamic acid group or a stilbenyl group.

10. The photo-dimerization functional group-containing organopolysiloxane according to claim 2, wherein the photo-dimerization functional group is an organic group comprising a cinnamic acid group or a stilbenyl group.

11. The photo-dimerization functional group-containing organopolysiloxane according to claim 1, wherein 3.0≦m+n≦10,000.

12. The photo-dimerization functional group-containing organopolysiloxane according to claim 9, wherein 3.0≦m+n≦10,000.

13. The photo-dimerization functional group-containing organopolysiloxane according to claim 10, wherein 3.0≦m+n≦10,000.
